(19) United States
(12) Patent Application Publication
(10) Pub. No.: US 2019/0270206 A1
(43) Pub. Date: Sep. 5, 2019

(54) CONTROL DEVICE AND CONTROL METHOD FOR INDUSTRIAL MACHINES WITH CONTROLLED MOTION DRIVES

(71) Applicant: KEBA AG, Linz (AT)

(72) Inventor: Emanuel MAIER, Schleissheim (AT)

(73) Assignee: KEBA AG, Linz (AT)

(21) Appl. No.: 16/332,980

(22) PCT Filed: Sep. 11, 2017
(86) PCT No.: PCT/AT2017/060223

§ 371 Date: Mar. 13, 2019

(30) Foreign Application Priority Data
Sep. 14, 2016 (AT) A50822/2016

(51) Int. Cl. B25J 13/06; G05B 19/409

(52) U.S. Cl. CPC B25J 13/06; G05B 19/409; G05B 2219/43186; G05B 2219/39001; G05B 2219/33004; B25J 13/065

(57) ABSTRACT

A control device for industrial machines with controlled motion drives for machine components has at least one operating element which is configured to manually influence or set adjustment movements of the machine components and which is designed as a rotary actuator operating element comprising a continuously rotatable actuating member. The rotary actuator operating element and a push-button element are connected to an electronic evaluation and control device which is configured to provide two interactive modes. The first interactive mode sets a movement speed and a desired movement direction of a machine component to be controlled and the push-button must be actuated or activated and simultaneously or additionally the actuating member of the rotary actuator operating element must be adjusted. In the second interactive mode a rotary actuation member is enabled without simultaneous actuation of the push-button element.

The invention relates to a control device for industrial machines having controlled motion drives for machine components, in particular for machine axes that are movable under control, and to a method for operating an electronic control device for industrial machines having controlled motion drives, as is specified in claims 1 and 14.

From EP 1 403 619 B1, an electronic operating system is known that is provided as part of a driver information system in motor vehicles. In addition, this operating system is also intended to be able to be used as a display and operating device in connection with the control of machines, for instance in industrial manufacture. This operating system comprises an electronic control unit that has an arithmetic logic unit, a display unit that is suitable for visualization of graphical representations, and a control unit with which manual interventions regarding the functions of the respective system may be undertaken. In order to change parameters of the system, provision is made here that an indicator mark in the manner of a cursor is moved over the display surface of the display unit and an available function is selected by this means. After corresponding selection of the desired function by cursor-like movement of the display mark, another control element is activated in order to be able to change parameters therewith. This second control element allows, for example, a change of parameter values in conjunction with the function previously selected via a first control element. The measures described in this document are only suitable to a limited extent for the control or influencing of machines having motion drives. Instead, the measures described are suitable for use in conjunction with relatively noncritical functions such as occur in driver information systems in motor vehicles. Operation of industrial machines having motion drives using this prior art design would be satisfactory to only a limited extent.

EP 1 075 979 B1 describes a method for operating a multifunction operating device that likewise can be employed advantageously in conjunction with motor vehicles. In this multifunction operating device, menus and/or control functions are displayed on a display unit, and the said menus and/or functions are activated via button elements and at least one rotary actuator element. At least one of these rotary actuator elements in this design is freely programmable with respect to its rotary directions and rotary positions and/or latching positions and/or actuating stops. This free programming is accomplished here in such a manner that haptic feedback that is associated with the menus or functions called up in each case is produced in the rotary actuation path. Associated with each actuation function in this design is a set of haptic data that can be adapted dynamically to a change in function data. In this way, intuitive operation is made possible since the operator is provided with haptic feedback that is automatically adapted as a function of the applicable menus or functions. Operation of industrial machines having motion drives using the specified device is feasible to only a limited extent, however.

The task of the present invention was to overcome the disadvantages of the prior art and to provide a device and a method by means of which a user is able to undertake the most feasible possible operation of industrial machines having motion drives.

In particular, a task of the present invention is to improve the operability or programmability of machines having components that are movable under control or actively adjustable machine axes.

This task is accomplished by a device and a method according to the claims.

Accordingly, a control device for industrial machines having controlled motion drives for machine components is provided, which control device comprises at least one human-machine interface, in particular control-related input and output means. In this design, at least one control element is designed for manual influencing or specification of adjustment movements of at least one of the machine components, for example in the manner of machine axes that are adjustable under control. The corresponding control device is distinguished in that at least one control element is implemented as a rotary control element with an actuating element that is continuously rotary, in particular rotatable without stops, and in that this rotary control element is in functional interaction with at least one momentary switch element. The rotary control element and the momentary switch element are connected to an electronic analysis and control device, which is equipped at least for provision of a first and a second control-related operating or interaction mode. The first interaction mode is provided here for specification of a rate of travel desired by an operator and of a desired direction of travel of a machine component to be driven, in which first interaction mode the momentary switch element is to be actuated or to be activated, and at the same time the actuating element of the rotary control element is to be moved in the relevant direction of rotation by an angle of rotation corresponding to the desired rate of travel, wherein the rate of travel is defined by the size of the angle of rotation and the direction of travel of a machine component to be driven is defined by the direction of rotation. In the second interaction mode, a rotary actuation of the actuating element of the rotary control element without simultaneous actuation of the momentary switch element is provided, wherein, instead of a specification of a rate of travel, a position change of a machine component to be driven takes place that is proportional to the size of the rotary actuation, in particular as a function of the angle of rotation traveled.

Improved manual operation or control of motion drives, or of machine components moved thereby, is made possible as a result of the specified measures. In particular, a system of operation for an operator is created as a result, which makes possible a quickly understood or intuitive manual operation of movable machine components, in particular of so-called machine axes. The corresponding operating actions in this regard can be carried out relatively conveniently and, at the same time, in an error-preventive way. As a result of the unambiguous operating actions, or as a result of the associated deliberate issuance of motion control commands, the risk of damage to a controlled machine can be minimized and the safety of persons can be improved. In particular, the risk arising from manually driven machines can be reduced because unintended or unwanted control commands can be avoided or prevented. Due to the simple mode change, moreover, it is also possible to achieve especially rapid and also precise implementation of desired machine movements, by which means high user acceptance and cost effectiveness can be achieved.

These advantageous effects are achieved by means including the fact that the actuating element for the issuance of motion control commands is designed as a rotary control element in which a continuous rotatability of the actuating element is available. For initiation by the user or manual initiation of a movement of a machine component or of a machine axis, on the one hand a first interaction mode is available in which the absolute angle of rotation of the actuating element determines the rate of travel and the direction of travel of the machine component.

For engagement of this first interaction mode, in this design the momentary switch element is to be simultaneously actuated or activated in a simple manner. The relevant rate of travel of the machine component is then derived on the basis of a starting or initial position of the actuating element, which starting or initial position can be predefined or can be defined by the last valid rest position of the actuating element. In this first interaction mode, continuous rotation of the actuating element is not necessary, but instead the machine axis is driven or moved as a function of the relevant angle of rotation of the actuating element and as a function of the direction of rotation followed at the time. As a result, it is even possible for motions of machine components that continue for a relatively long time to be executed readily, since continuous rotation of the actuating element is not required.

The second available interaction mode is then present in a simple manner when the momentary switch element remains unactuated or is not activated. In this second interaction mode, the possibility exists for the operator to be able to proportion, as it were, or finely adjust the movement of the machine axis to be driven in order to be able to reach or assume end positions or target positions quickly and precisely. Thus, in this second interaction mode, in which no actuation of the momentary switch element takes place, a change over time in the angle of rotation of the actuating element is converted into a motion of the machine component. This means that, in this second interaction mode, a travel motion of the machine axis to be driven only occurs while a rotational motion of the actuating element is taking place. This is especially advantageous for sensitive positioning tasks of a machine component to be driven.

In order to be able to switch or change between the two interaction modes, in particular between the first interaction mode and the second interaction mode, quickly and without difficulty, the use of a momentary switch element is especially practical.

The measures according to claim 2 are also of benefit, because in this way an intuitive operating concept is present that avoids or prevents the occurrence of operating errors or stressful situations for an operator. In particular, an originally initiated and currently ongoing machine movement or axis movement can be stopped very quickly and easily at any time. If, namely, the momentary switch element is released by the operator while the first interaction mode is present, the corresponding machine movement or the axis movement of the machine component stops, preferably independently of the current angle of rotation of the actuating element. As a result, rapid halts or stops can be accomplished without the operator needing to consider special actions. Through simple deactivation of the momentary switch element, a control command for initiation of a stoppage of the driven machine component is at hand, which control command can be implemented directly or as directly as possible by the control device.

The measures according to claim 3 are also advantageous, however, because in this way a controlled decrease in the rate of travel of a machine component or machine axis until its stoppage can be initiated or carried out simply and intuitively by an operator. In particular, in this way a gentle shutdown can take place or a braking process that is adjustable with respect to the deceleration of a machine component that is to be moved can be carried out or specified simply and intuitively by an operator. Moreover, peak loads of the mechanical components of the machine can be avoided as a result, and sensitive manual operation or control of the relevant machine components or machine axes can be achieved on the whole.

The measures according to claim 4 are also useful, because a feedback channel from the control device to the operator can be created as a result, which can significantly increase the user-friendliness of the control system or of the machine control system. In particular, an improved interaction between the operator and the machine to be driven can be achieved in this way and, moreover, relatively safe, error-preventive, and simultaneously rapid operating action is achievable. Due to the implementation of haptic signaling or due to the utilization of the tactile perception capability of an operator, the respective sequences of motions or motion control commands can be initiated in an orderly and relatively reliable manner.

Practicable feedback can be achieved through the measures according to claim 5. In particular, it is achieved by this means that, in the event of an increasing angle of rotation of the actuating element and an associated higher rate of travel of the machine component, at the same time a higher resistance to rotary actuation is present for the operator, which resistance to rotary actuation the operator must intentionally overcome in order to further increase the rate of travel. As a result, “overregulation,” as it were, or an excessively rapid startup or excessively fast moving of the machine component is prevented.

This is particularly useful, especially when the direction of travel of the machine component is parallel or essentially parallel to the direction of view of the operator, since in these cases estimation of the actual rate of travel is relatively difficult for the operator. Thus, until now it was possible for such “overregulation” to take place for an operator even without his awareness. Due to the specified measures, this problem can be remedied efficaciously and reliably.

The control-related measures according to claim 6 are also useful, because an unwanted “over-rotation” of the actuating element during the course of the reverse rotation of the actuating element can be prevented by this means. In particular, through the controlled creation of a locking resistance or inhibition resistance via the rotational resistance generating means, it is possible to achieve the result that an overrunning of the initial position or neutral position occurs even in the case of a relatively fast reverse rotary motion of the actuating element into the neutral region or into its last rest position or initial position. A very fast backward movement of the actuating element by the operator always involves the danger that the actuating element is displaced in the opposite direction and consequently a movement of the machine component in the opposite direction is unintentionally initiated. This can be counteracted in a simple and effective manner through the measures according to claim 6. The corresponding control device can thus be operated in an intuitive, error-preventing, fast, and effortless manner. As a result of the variable controllability of the rotational resistance generating means, in this regard the initial position of the actuating element can be predefined to be fixed in each case, but can also be made dependent as a function of the most recent rest position or initial position of the actuating element.

An embodiment according to claim 7 is also advantageous, because the function assigned to the momentary switch element can be unmistakably represented to an operator as a result. In particular, unintended operating actions on the part of the operator can be prevented by this means because the momentary switch element appears as a structurally separate element to be actuated as needed. This is the case especially when the separate placement of the momentary switch element requires two-handed operation, in which the momentary switch element is to be activated with one hand, while the actuating element of the rotary control element is to be actuated with the operator's other hand.

The measures according to claim 8 are also useful, because an integral assembly is created thereby in which the functionalities of the rotary control element and of the momentary switch element are combined in one assembly.

However, the embodiment according to claim 9 is also of benefit, because one-handed operation is made possible thereby, in which the rotary control element can be rotated with one hand while at the same time the momentary switch element can be activated and deactivated as needed with the same hand of the operator or with the fingers of the same hand.

The measures according to claim 10 are also useful. In this design, the momentary switch element is positioned off-center on the rotatable actuating element, and thus is carried along analogously to the rotation of the actuating element. Due to the off-center or eccentric arrangement, a simpler orientation with respect to the relevant rotational position of the actuating element can be achieved for the operator. For example, a typical initial or rest position of the actuating element can be made apparent as a result. Moreover, ergonomic operation with only one finger is possible as a result, because, for example, the momentary switch element can be actuated with one finger, in particular the index finger, and a rotary or rotational movement of the actuating element can be carried out at the same time. This can be done either with the same finger or with the other fingers of the operator's hand. It is useful here when the actuating surface of the momentary switch element is designed to be recessed with respect to the surface of the actuating element.

The measures according to claim 11 are also useful, because a sort of “piggyback” design is provided as a result that permits an intuitive rotary and push actuation of the rotary control element. By this means, too, it is possible to switch or change between the two interaction modes especially easily and intuitively, and only one of the operator's hands is needed to be able to execute the relevant operating actions.

An embodiment according to claim 12 and/or 13 is also useful, because it is possible by this means to achieve sensor-based detection of the letting go or releasing of the actuating element by an operator. Such a “release detection” can be implemented in a simple manner, in particular can be associated with the rotary control element. In this design, a variety of physical operating principles are available to be able to automatically detect or distinguish whether the fingers of an operator are resting against the actuating element or are gripping the same, or whether the actuating element is gripped or actuated at certain predefined positions. As a result, a sensor-based switching between the two interaction modes can be implemented in a reliable manner, and at the same time intuitive operating action can be provided for the operator.

The task of the invention is additionally accomplished by the method according to the claims for operating an electronic control device for industrial machines. The advantageous actions and technical effects that can be achieved therewith are found in the above remarks and the following sections of the description.

For better understanding, the invention is explained in detail on the basis of the following figures.

The figures show, in highly simplified, schematic representation:

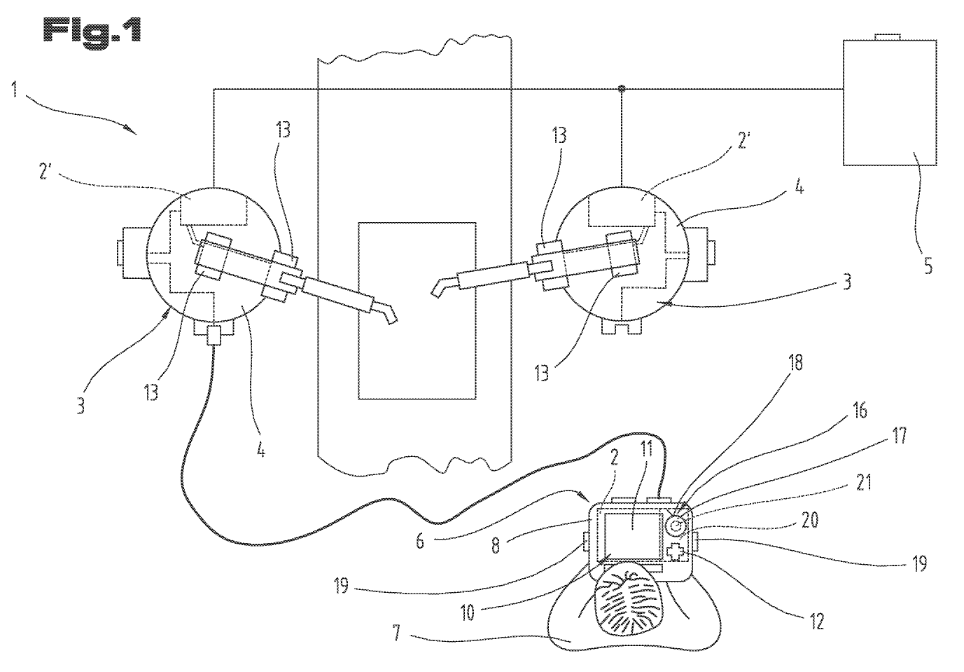

FIG. 1 a technical facility composed of multiple machines, in particular industrial robots, and an electronic control system employed therewith, which control system comprises multiple control devices and a human-machine interface in the manner of a portable, hand-held controller;

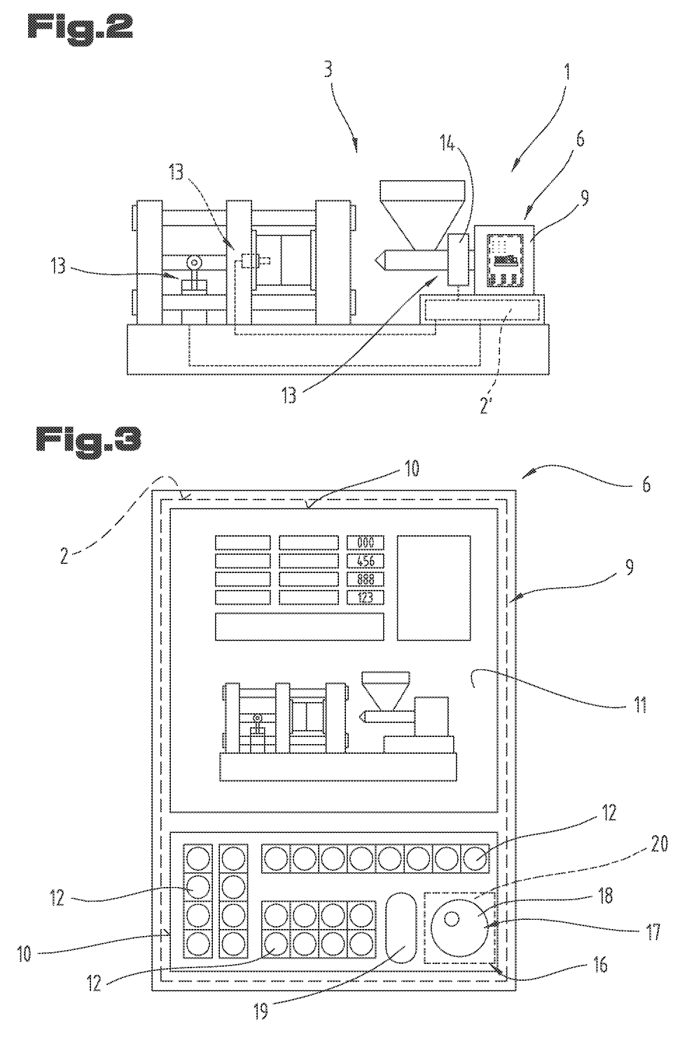

FIG. 2 a production machine, in particular an injection molding machine, that includes an electronic control device and a human-machine interface connected thereto in the manner of a stationary control panel;

FIG. 3 the control panel of the production machine from FIG. 2;

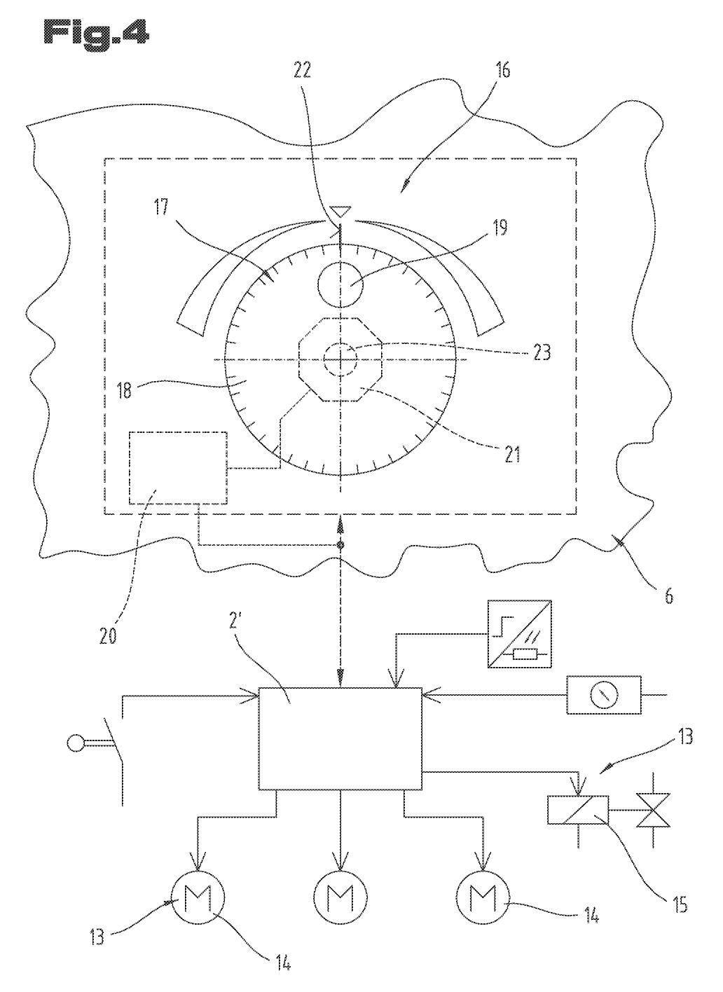

FIG. 4 a control device for industrial machines with a rotary control element that is used for the operation or influencing of motion drives, and in addition comprises a momentary switch element for need-based, user-initiated switching between at least two interaction modes;

FIG. 5 an embodiment of a rotary control element in combination with an electromechanical momentary switch element;

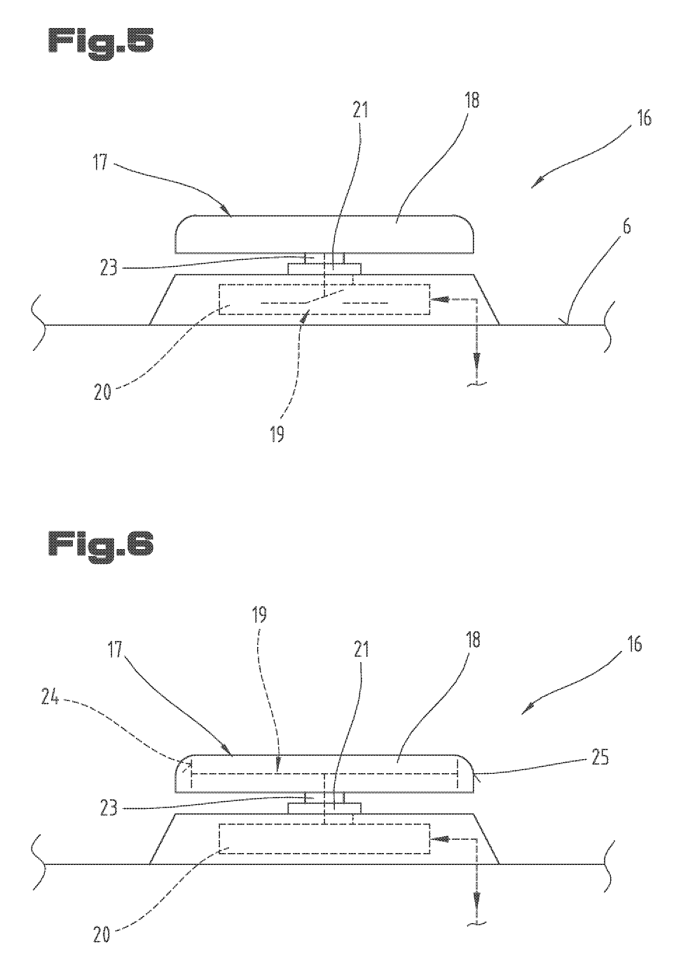

FIG. 6 another embodiment of a rotary control element in combination with a sensor-based momentary switch element.

As an introduction, it should be stated that the same parts are labeled with the same reference symbols or the same component designations in the different embodiments described, wherein the disclosures contained in the description as a whole can be applied analogously to the same parts having the same reference symbols or the same component designations. Also, the position information chosen in the description, such as top, bottom, lateral, etc., for example, refers to the figure being directly described and shown, and this position information must be transferred analogously to the new position in the event of a change in position.

In FIGS. 1 to 3, exemplary embodiments of electrotechnical or electronic control systems 1 are shown that can be used for the automation or control of industrial facilities. Such an industrial facility or its control system 1 comprises at least one electronic control device 2, 2′, or a multiplicity of electronic control devices 2, 2′ that are arranged in distributed fashion can also be provided. A corresponding facility comprises at least one machine 3, or a multiplicity of possibly interacting machines 3 or machine components. The at least one electronic control device 2, 2′ preferably is software-controlled in design, and serves primarily to implement the relevant control functions of the relevant industrial machine 3 or to be able to monitor, influence, and/or program the sequences of the machine 3.

In accordance with the embodiment from FIG. 1, such an industrial machine 3 is composed of at least one industrial robot 4. Such an industrial robot 4 can be part of an assembly or manufacturing facility. Due to a data networking of the control devices 2, 2′ in question, it is possible to provide that the industrial robots 4 can interact in a control-related manner. Such a data-related or control-related networking between multiple industrial robots 4 can also include a central process control computer 5. With regard to a control architecture and networking that are centralized, distributed, hierarchical, or otherwise constructed, an extremely wide variety of embodiments are possible here, which can be chosen in accordance with the applicable requirements.

At least one human-machine interface 6 (HMI) is associated with or can be associated with at least one control device 2′ in at least one machine 3 in this design. Control-relevant interactions between an operator 7 and the respective machine 3 are made possible by means of this human-machine interface 6.

In the exemplary embodiment according to FIG. 1, the control-related human-machine interface 6 is composed of a mobile or portable hand-held controller 8. In the embodiment from FIG. 2, the human-machine interface 6 is defined by a stationary control panel 9. The human-machine interfaces 6 in question can thus also be referred to as user interfaces.

A generic hand-held controller 8 or control panel 9 has at least one input device 10, as for example a touch screen 11, input keys 12, switches, or other electrical or electromechanical input means. In addition, visually and/or audibly detectible output means can be provided. In the case of a generic hand-held controller 8 or control panel 9, the previously mentioned touch screen 11, in particular, as well as luminous elements or signaling lamps can be provided for the display of system-relevant data or states. The range of functions and the embodiment of the relevant input device or of the relevant output device depend strongly on the relevant application, in particular on the technical complexity of the machine 3 or facility to be controlled. It is important here that the operator 7 can regulate or monitor, influence, and/or program the required control-related sequences by means of the input device 10 and a suitable output device, in particular by means of the previously mentioned touch screen 11.

The control device 2 implemented in the human-machine interface 6, in particular in the hand-held controller 8 or in the control panel 9, and the control device 2′ associated with a machine 3 can be in data-related or control-related interaction through wired and/or wirelessly implemented communication interfaces.

As is known per se, controllable motion drives 13, in particular that can at least be activated and deactivated, are provided for automation of the relevant machines 3, which motion drives are line-connected to the relevant control device 2′. Often such motion drives 13 are also adjustable or variable on demand with respect to their drive speed and/or drive power or driving force. As illustrated in FIG. 2 and FIG. 4, such motion drives 13 can be composed of motors 14, of hydraulic cylinders, of proportional solenoid valves 15, or of other elements for active or controllable movement of machine components. The corresponding motion drives 13 are also understood to include actuators with which an adjustment movement of a machine component can be produced or initiated. Such a motion drive 13 and the respective machine component can also be referred to as a machine axis in this context. A controllable machine component or machine axis can be understood to include, for example, an articulated arm of an industrial robot 4, a feed unit, a machining unit of a machine tool, a positioner of a production machine, and the like. Typically, a multiplicity of sensors, limit switches, and/or transmitters can also be connected to such a machine control device 2′, as is generally known and is shown by way of example in FIG. 4. As a result, movement or function sequences of the machine in question can be performed fully automatically, or at least partially automatically, or be monitored automatically.

For manual influencing or for programming of the relevant motion drives 13 or machine components, at least one control element 16 is provided at the relevant human-machine interface 6 for manual influencing or specification of adjustment movements of at least one of the machine components or machine axes. This manual influencing or specification of adjustment movements by an operator 7 preferably comprises the possibility of a change in speed and/or power of the motion drive 13 to be driven or that can be selectively driven. In addition, control elements, in particular button elements or switching devices, can be implemented that are provided for activation and deactivation of a selected or drivable motion drive 13.

At least one of the control elements 16 at the human-machine interface 6 in this case is designed as a rotary control element 17 with an actuating element 18 that is continuously rotatable or rotatable without stops. “Continuous rotatability” means here that the rotary control element 17 or its actuating element 18 is designed such that there are no mechanical end stops or no permanent limitation with regard to the rotational mobility of the actuating element 18. This is in contrast to a typical potentiometer or adjustable ohmic resistor, in which a rotation or adjustment range of approximately 270° is normally provided. The rotary control element 17 according to the claims is instead comparable to a so-called override potentiometer, which is to say the rotary control element 17 can be implemented as an incremental encoder that is continuously rotatable. What is important is that the rotary control element 17 permits continuous rotatability of its actuating element 18, for example disk-shaped or wheel-shaped actuating element, or an associated, unlimited output of sensor pulses or increments.

The rotary control element 17 on the hand-held controller 8 (FIG. 1) or on the control panel 9 (FIG. 3) is in functional interaction with at least one momentary switch element 19 in this design. This momentary switch element 19, executed in hardware and/or implemented by software means, preferably is positioned within reach of the rotary control element 17 in this regard. For example, a software-based implementation can take place in the manner of a so-called “soft key,” for which the touch screen 11 can preferably be involved. In particular, the functionality of the momentary switch element 19 can also be provided by means of the touch screen 11.

In the embodiment from FIG. 1, two momentary switch elements 19 are provided that are implemented at ergonomically easily reachable positions on the housing of the hand-held controller 8. According to the embodiment from FIG. 3, the momentary switch element 19 is located directly next to the rotary control element 17. The momentary switch elements 19 from FIGS. 1 and 3 are executed in hardware and are evaluated by software means.

The rotary control element 17 and the at least one momentary switch element 19 are connected to an electronic analysis and control device 20. In particular, signals or actuation states of the momentary switch element 19 and of the rotary control element 17 can be sensed and evaluated by the analysis and control device 20.

The analysis and control device 20 in this case can be designed as a standalone or separate unit, or else can be implemented by the control device 2, 2′. In particular, the control device 2, 2′ can undertake at least subtasks of the analysis and control device 20. This is the case chiefly because the functionalities of the analysis and control device 20 can be realized predominantly through software means or programming means, and therefore can provide a range of functions of the control device 2, 2′ in a simple manner. A combinatorial interaction is thus also possible in order to achieve an implementation of the analysis and control device 20.

The analysis and control device 20, which is structurally separate and/or at least partially implemented by software means, is equipped at least to provide a first and a second operating or interaction mode M1, M2. These two usage or interaction modes M1, M2 are to be primarily understood as behaviors of the control device 2, 2′ implemented by software means.

According to the invention, the first interaction mode M1 is intended here for specification of a rate of travel desired by an operator 7 and of a desired direction of travel of a machine component to be driven. In this first interaction mode M1, the momentary switch element 19 is to be actuated or to be activated by the operator 7, and at the same time, in particular in addition, the actuating element 18 of the rotary control element 17 is to be moved in the relevant direction of rotation by an angle of rotation corresponding to the desired rate of travel in order to bring about a movement of a machine component to be driven. The rate of travel here is defined by the size of the angle of rotation and the direction of travel of a machine component to be driven is defined by the direction of rotation. Thus, for example, a slower rate of travel is brought about in the case of a 25° rotation of the actuating element 18 than in the case of a rotation of the actuating element 18 about a twist angle of 50°. A counterclockwise rotation of the actuating element 18 here can cause a movement of the machine component to the left or to the back (or downward), and a clockwise rotation of the actuating element 18 can, for example, cause a movement of the machine component to the right or to the front (or upward)—or vice versa. In this first interaction mode M1, therefore, the rate of travel is determined as a function of the twist angle of the actuating element 18, and the direction of travel of the machine component that is driven or to be driven is determined as a function of the rotational direction. What is important here is that for engagement of this first interaction mode M1, the correspondingly provided or designed momentary switch element 19 is to be actuated or activated simultaneously or at the same time. The first interaction mode M1 in this case is active as long as the momentary switch element 19 is actuated or activated by the operator 7.

In the second interaction mode M2, in contrast, a rotary actuation of the actuating element 18 of the rotary control element 17 takes place without a simultaneous actuation of the momentary switch element 19. This means that the second interaction mode M2 is in effect or is engaged when the momentary switch element 19 is not actuated or is inactive. Instead of a specification of a rate of travel as in the first interaction mode M1, in the second interaction mode M2 a position change of a machine component to be driven that is proportional to the size of the rotary actuation, in particular proportional to the angle of rotation traveled in sum by the actuating element 18, is provided or is to be implemented by the control device 2, 2′. This means that the relevant motion of the machine component is executed as long as a rotary actuation of the actuating element 18 is present or is detected by the analysis and control device 20.

The rate of travel during the course of the second interaction mode M2 can take on a fixed, predefined value in this case, or can be selectively preset by the operator 7. A certain variation of the rate of travel of the machine axis as a function of a variation of the rotational speed of the continuous rotary motion of the actuating element 18 is also possible here. What is important is that in the second interaction mode M2, a movement of the machine component in question is only present or is only executed as long as the actuating element 18 is being turned or is being rotated. Upon release or termination of the rotary motion of the actuating element 18, a stopping of the driven machine component takes place immediately. Most notably, a precise or fine positioning of a machine component can be achieved in this second interaction mode M2. In the second interaction mode M2, therefore, an initiation and execution of a movement of the machine component to be driven takes place via a continuous rotation of the actuating element 18.

In connection with the first interaction mode M1, it is also possible, according to a practicable control sequence, to provide that a travel motion of the machine component to be driven is terminated immediately or as promptly as possible as a result of a release or a deactivation of the momentary switch element 19 during the specification of a rate of travel for the driven machine component. In accordance with this analysis routine implemented in the analysis and control device 20, an immediate stopping of the movement of the machine component therefore takes place as soon as the momentary switch element 19 is released by the operator 7. This corresponds more or less to a termination or discontinuation of the control functionalities of the first interaction mode M1.

However, the control sequence can also take place in such a manner that, during the course of the specification of a rate of travel according to the first interaction mode M1, and a rotary actuation of the actuating element 18 back into the initial position, in particular back into the original rest position, undertaken by an operator 7 in this context, the rate of travel of the machine component to be driven is reduced in the extent of the returning rotary actuation, and ultimately the adjustment movement of the machine component that is to be driven or that is driven is stopped upon reaching the initial position, in particular upon reaching the original rest position. This corresponds to a user-initiated speed reduction of the machine component with a deceleration of the rate of travel proportional to the reverse rotary motion of the actuating element 18. In particular, adjustment movements that fade away or gradually decrease in speed with respect to the machine component to be driven can be achieved in this way. This control function is also especially intuitive for an operator 7 and at the same time can be controlled well and is simple to execute.

In accordance with an embodiment as is illustrated in FIG. 4, the actuating element 18 can be in mechanical interaction or be coupled in terms of motion with a rotational resistance generating means 21 that is variable under control. This motion-coupling here is such that the rotational resistance generating means 21 can create, as a function of a driving by the analysis and control device 20, an activatable and deactivatable torsional resistance or a release and blocking of the actuating element 18, or a rotational resistance that is variable under control, in particular a continuously or discontinuously variable rotational resistance, with respect to the actuating element 18. This rotational resistance can also be understood here as holding torque or braking torque that can be produced via the rotational resistance generating means 21 and in this case is transmitted to the actuating element 18 or to internal components of the rotary control element 17. In particular, the rotational resistance generating means 21 acts in a controlled or controllable manner on the rotational mobility of the actuating element 18.

The rotational resistance generating means 21 can be implemented here through any principles or systems known from the prior art. It is useful if the rotational resistance generating means 21 comprises actuating elements that are based on the magnetorheological principle, in particular that include magnetorheological fluids. To some extent, it is possible that the rotational resistance generating means 21 comprises mechanically or electromechanically controllable or activatable braking or blocking means.

In accordance with a useful embodiment, it is possible to provide that the rotational resistance generating means 21 is drivable or is driven by the analysis and control device 20 in such a manner that a rotational resistance or the corresponding actuation resistance of the actuating element 18 is increased in connection with an increase provided by an operator 7 in the rate of travel of a machine component that is to be driven or that is driven. As a result, it is intuitively discernible to an operator that his control or motion commands are entering speed ranges that are relatively high. This haptic feedback is particularly advantageous, especially when the machine 3 or machine component is executing a movement that is parallel to the direction of view of the operator, in particular runs in the direction away from the operator 7 or runs in the direction toward the operator 7. Above all in such directions of travel, namely, estimation of the actual speed of the machine component is relatively difficult for the operator 7 to carry out.

According to another practicable embodiment, it is possible to provide that the rotational resistance generating means 21 is drivable or is driven by the analysis and control device 20 in such a manner that, when the initial position 22 of the actuating element 18 is reached, which initial position 22 can be predefined to be fixed, but can also be defined by the original or last initial position or rest position of the continuously rotatable or rotational actuating element 18, the further rotatability of the actuating element 18 is at least temporarily blocked or inhibited. In particular, it can be useful in connection with a reverse rotation of the actuating element 18 into the initial position 22 or into the last initial position or rest position, to block, in particular to lock, or alternatively to inhibit, a further rotatability of the actuating element 18 beyond this initial position 22 or beyond the last initial position or rest position, either for a predefined period of time or during the occurrence or action of an actuating torque with respect to the actuating element 18. As a result, it is feasibly signaled to an operator 7 in an effective and advantageous manner that the initial position 22, or the last initial position or rest position, which can be defined by the original rest position, has been reached. In particular, an unwanted “over-rotation” of the actuating element 18 during the course of a reverse rotation of the actuating element 18 for initiation of a controlled motion stop can be prevented by this means.

The rotational resistance generating means 21 can also be used to produce detent steps that can convey to the operator 7, at least haptically, or even haptically and audibly, the angle of rotation traveled in each case by the actuating element 18. The number of detent steps here that are easy to overcome but are nevertheless perceptible can be strictly predefined or can be automatically adjusted as a function of the respective motion function. Depending on requirements, coarse or fine detent increments can be provided, wherein up to 100 uniformly distributed detent steps per full rotation of the actuating element 18 can easily be perceived tactilely by an operator 7.

As is evident from the schematic representations in FIGS. 1 and 3, the momentary switch element 19 for initiation of the first interaction mode M1 can be designed to be structurally separate and be located apart from the rotary control element 17. In accordance with a useful embodiment, as has been schematically illustrated in FIG. 4, the momentary switch element 19 can also be designed as an integral or integrated component of the rotary control element 17. In particular, the rotary control element 17 and the momentary switch element 19 form an integral assembly in this case.

In accordance with a practicable embodiment, it is also possible in this regard to provide that the momentary switch element 19 is implemented directly on the actuating element 18 of the rotary control element 17 or is supported by the actuating element 18. Accordingly, the momentary switch element 19 is carried along or, in the event of a rotary motion of the actuating element 18, is turned or rotated along therewith. In accordance with a possible improvement, provision is made here that the momentary switch element 19 is arranged so as to be eccentric to the axis of rotation 23 of the actuating element 18. This means that the momentary switch element 19 in this design is positioned off-center with respect to the actuating element 18 that is essentially circular, polygonal, or elliptical in top view.

According to an embodiment as has been schematically illustrated in FIG. 5, the rotary control element 17 can be designed to be at least partially raised with respect to the user surface of the human-machine interface 6. Ergonomic operation of the pivotably rotational actuating element 18 is made possible as a result. The actuating element 18 can be disk-shaped or wheel-shaped in design, wherein the axis of rotation 23 of the actuating element 18 is perpendicular or essentially perpendicular to the user surface of the human-machine interface 6.

Furthermore, it is possible to provide that the momentary switch element 19 carries or accommodates the rotary control element 17 or its actuating element 18. The momentary switch element 19 can be activated and deactivated through manual displacement of the rotary control element 17 or, respectively, of the actuating element 18 in the axial direction with respect to the axis of rotation 23 of the actuating element 18. In particular, in this case a sort of “piggyback” arrangement can be provided that permits a combinatorial push and rotary actuation of the rotary control element 17 and the momentary switch element 19. In particular, the actuating element 18 or the entire rotary control element 17 sits, as it were, on the momentary switch element 19 in this design.

According to an embodiment as has been schematically illustrated in FIG. 6, the momentary switch element 19 can also be implemented as a contactlessly activatable sensor 24, in particular as a capacitive sensor, as a pressure sensor, or as a brightness sensor. A momentary switch function can also be implemented by this means. In particular, it is possible to detect whether an operator 7 has activated the momentary switch element 19 implemented by sensors, or whether inactivity is present.

It can also be useful to design the touch-sensitive sensor 24 functioning as the momentary switch element 19 as a touch-sensitive section 25 of the actuating element 18. This touch-sensitive section 25 can be defined in this case by the lateral section of a wheel-shaped or disk-shaped actuating element 18, while the upper face of the actuating element 18 can be non-touch-sensitive, and thus have no switching function. Consequently, a selective activation and deactivation of the sensor-based momentary switch element 19 can be achieved by alternately gripping or operating the actuating element 18 at its top or at its circumferential section 25. This can be achieved in a simple manner by grasping the actuating element 18. In conjunction with an appropriate rotary control element 17, a high level of operating convenience can be achieved.

The technical measures and method sequences specified above can be implemented through a combination of hardware and software components. The applicant's application for protection is therefore directed to device claims as well as to corresponding method claims.

The exemplary embodiments show possible embodiment variants, wherein it must be noted here that the invention is not restricted to the embodiment variants specifically shown, but rather various combinations of the individual embodiment variants with one another are also possible, and this possibility for variation lies within the ability of a person skilled in the art of this technical field, on the basis of the teaching for technical action provided by the present invention.

The scope of protection is determined by the claims. However, the description and the drawings must be referred to for an interpretation of the claims. Individual characteristics or combinations of characteristics of the different exemplary embodiments that are shown and described can represent independent inventive solutions on their own. The task on which the independent inventive solutions are based can be derived from the description.

As a matter of form, it should be noted in conclusion that, for a better understanding of the structure, some elements were shown not to scale and/or greater in size and/or smaller in size.

1 control system

2, 2′ control device

3 machine

4 industrial robot

5 process control computer

6 human-machine interface

7 operator

8 hand-held controller

9 control panel

10 input device

11 touch screen

12 input key

13 motion drive

14 motor

15 solenoid valve

16 control element

17 rotary control element

18 actuating element

19 momentary switch element

20 analysis and control device

21 rotational resistance generating means

22 initial position

23 axis of rotation

24 sensor (contactless)

25 section (touch-sensitive)

1. A control device (2, 2′) for industrial machines having controlled motion drives (13) for machine components, comprising
a human-machine interface (6) with at least one control element (16) for manual influencing or specification of adjustment movements of at least one of the machine components, wherein
at least one control element (16) is implemented as a rotary control element (17) with a continuously rotatable actuating element (18), wherein
the rotary control element (17) is in functional interaction with at least one momentary switch element (19), wherein the rotary control element (17) and the momentary switch element (19) are connected to an electronic analysis and control device (20), which is equipped at least for provision of a first and a second interaction mode (M1, M2), wherein
the first interaction mode (M1) is provided for specification of a rate of travel desired by an operator and of a desired direction of travel of a machine component to be driven, in which first interaction mode (M1) the momentary switch element (19) is to be actuated or to be activated, and at the same time or in addition the actuating element (18) of the rotary control element (17) is to be moved in the relevant direction of rotation by an angle of rotation corresponding to the desired rate of travel, wherein the rate of travel is defined by the size of the angle of rotation and the direction of travel of a machine component to be driven is defined by the direction of rotation, and wherein
in the second interaction mode (M2), a rotary actuation of the actuating element (18) of the rotary control element (17) without a simultaneous actuation of the momentary switch element (19) is provided, wherein, instead of a specification of a rate of motion, a position change of a machine component to be driven takes place that is proportional to the size of the rotary actuation, in particular as a function of the continuously traveled angle of rotation of the actuating element (18), wherein
the actuating element (18) is in mechanical interaction with a rotational resistance generating means (21) that is variable under control, and wherein
the rotational resistance generating means (21) is drivable by the analysis and control device (20) in such a manner that, when an initial position (22) or a last rest position of the actuating element (18) is reached as a result of a reverse rotation of the actuating element (18) by an operator, a rotatability of the actuating element (18) beyond this initial position (22) or last rest position is blocked or inhibited for a predefined period of time, or during the action of an actuating torque with respect to the actuating element (18), so that the reaching of the initial position (22) or, respectively, the last rest position of the actuating element (18) is haptically signaled to an operator.

2. The control system according to claim 1, wherein a control sequence takes place in such a manner that a travel motion of the machine component to be driven is terminated as a result of a release or a deactivation of the momentary switch element (19) during the specification of a rate of travel according to the first interaction mode (M1).

3. The control system according to claim 1, wherein a control sequence takes place in such a manner that, during the course of the specification of a rate of travel according to the first interaction mode (M1), and a rotary actuation of the actuating element (18) back into an initial position (22) of the actuating element (18), or back into a last rest position of the actuating element (18), undertaken by an operator in this context, the rate of travel of the machine component to be driven is reduced in the extent of the returning rotary actuation, and the adjustment movement of the machine component to be driven is stopped upon reaching the initial position (22) of the actuating element (18), or respectively upon reaching the last rest position of the actuating element (18).

4. (canceled) .

5. The control system according to claim 1, wherein the rotational resistance generating means (21) is drivable by the analysis and control device (20) in such a manner that a rotational resistance of the actuating element (18) is increased in connection with an increase provided by an operator in the rate of travel of a machine component that is to be driven.

6. (canceled)

7. The control system according to claim 1, wherein the momentary switch element (19) is designed to be structurally separate and is located apart from the rotary control element (17).

8. The control system according to claim 1, wherein the momentary switch element (19) is designed as an integrated component of the rotary control element (17).

9. The control system according to claim 8, wherein the momentary switch element (19) is implemented on the actuating element (18) of the rotary control element (17).

10. The control system according to claim 9, wherein the momentary switch element (19) is arranged so as to be eccentric to an axis of rotation (23) of the actuating element (18).

11. The control system according to claim 1, wherein the momentary switch element (19) carries or accommodates the rotary control element (17), and in that the momentary switch element (19) can be activated and deactivated through manual displacement of the rotary control element (17) or of its actuating element (18) in the axial direction with respect to an axis of rotation (23) of the actuating element (18).

12. The control system according to claim 1, wherein the momentary switch element (19) is designed as a contactlessly activatable sensor (24), in particular as a capacitive sensor or as a brightness sensor, or is implemented as a pressure sensor.

13. The control system according to claim 1, wherein the momentary switch element (19) is designed as a touch-sensitive section (25) of the actuating element (18).

14. A method for operating an electronic control device (2, 2′) for industrial machines (3) having controlled motion drives (13) for machine components, wherein a human-machine interface (6) with at least one control element (16) for manual influencing or specification of adjustment movements of at least one of the machine components is provided, wherein
at least one control element (16) is implemented as a rotary control element (17) with a continuously rotatable actuating element (18), wherein
the rotary control element (17) is in functional interaction with at least one momentary switch element (19), wherein
the rotary control element (17) and the momentary switch element (19) are connected to an electronic analysis and control device (20), which is equipped at least for provision of a first and a second interaction mode (M1, M2), wherein
the first interaction mode (M1) is provided for specification of a rate of travel desired by an operator and of a desired direction of travel of a machine component to be driven, in which first interaction mode (M1) the momentary switch element (19) is to be actuated or to be activated, and at the same time or in addition the actuating element (18) of the rotary control element (17) is to be moved in the relevant direction of rotation by an angle of rotation corresponding to the desired rate of travel, wherein the rate of travel is defined by the size of the angle of rotation and the direction of travel of a machine component to be driven is defined by the direction of rotation, and wherein
in the second interaction mode (M2), a rotary actuation of the actuating element (18) of the rotary control element (17) without a simultaneous actuation of the momentary switch element (19) is provided, wherein, instead of a specification of a rate of motion, a position change of a machine component to be driven takes place that is proportional to the size of the rotary actuation, in particular as a function of the continuously traveled angle of rotation of the actuating element (18), wherein
the actuating element (18) is in mechanical interaction with a rotational resistance generating means (21) that is variable under control, and wherein
the rotational resistance generating means (21) is driven by the analysis and control device (20) in such a manner that, when an initial position (22) or a last rest position of the actuating element (18) is reached as a result of a reverse rotation of the actuating element (18) by an operator, a rotatability of the actuating element (18) beyond this initial position (22) or last rest position is blocked or inhibited for a predefined period of time, or during the action of an actuating torque with respect to the actuating element (18), so that the reaching of the initial position (22) or, respectively, the last rest position of the actuating element (18) is haptically signaled to an operator.
